(19) United States
(12) Patent Application Publication
(10) Pub. No.: US 2026/0130354 A1
(43) Pub. Date: May 14, 2026

(54) SMART AUTONOMOUS TOWER SYSTEM FOR INSECT EXTERMINATION AND MONITORING

(71) Applicant: TECSOIL AUTOMAÇÃO E SISTEMAS S.A., Araçatuba (BR)

(72) Inventors: Tiago Pereira Scarpin, Araçatuba (BR); Carlos Manuel Zayas Barrera, Araçatuba (BR); Jed Nie, Guangdong (CN); Huiling Chen, Shenzhen (CN); Richard Elias Fernandes Leite, Araçatuba (RR); Leonardo Golia Bonatto, Araçatuba (BR)

(73) Assignee: TECSOIL AUTOMAÇÃO E SISTEMAS S.A., Araçatuba, SP (BR)

(21) Appl. No.: 19/377,436

(22) Filed: Nov. 3, 2025

(30) Foreign Application Priority Data
Nov. 8, 2024 (BR) 1020240233735

(51) Int. Cl. A01M 1/22; A01M 1/04; B08B 1/12; B08B 1/34; G06V 40/10; H02J 7/35; H05C 1/06

(52) U.S. Cl. CPC A01M 1/223; B08B 1/12; B08B 1/34; G06V 40/103; H02J 7/35; H05C 1/06; A01M 1/04; H02J 2101/25

(57) ABSTRACT

The present invention relates to a system of autonomous towers for exterminating and monitoring insects that comprises a main tower and at least one slave tower, wherein the main tower comprises: a self-sustaining power supply system composed of a solar panel; a solar charge controller, and a storage battery, configured to provide continuous power, independently of an external source of electricity; a centralized control device through a microcomputer (Raspberry Pi) that manages the operation of the system and collects data from the slave towers through a LoRa communication network; a camera coupled to capture images of the eliminated insects, connected to a 4G module for transmitting the images to a remote server, where an artificial intelligence algorithm processes and identifies the species and quantity of insects; a high-voltage grid composed of a Positive Voltage Network (+) and a Negative Voltage Network (−) configured to release an electric discharge upon contact with insects, eliminating them instantly, wherein each slave tower comprises: a power supply system composed of a solar panel, solar controller, and battery, ensuring independent operation from an external source of electricity; a Lora communication module configured to connect to the main tower and transmit monitoring data, in addition to receiving commands, allowing for expansion of the coverage area and auxiliary action in the extermination of insects

### FIELD OF THE INVENTION

The present invention relates to the technical field of pest control, specifically involving a pest extermination device with multiple structures and functions, as well as to the technical field of insect elimination and monitoring, a Tower system used to kill insects and perform the data collection and transmission relevant to agricultural cultivation.

### BACKGROUND OF THE INVENTION

In pest control, traditional methods have been widely used, such as chemical pesticides and mechanical insect-killing devices. However, these solutions have significant limitations. Pesticides, in addition to causing negative environmental impacts, can lose effectiveness due to pests developing resistance over time. Furthermore, these methods lack the possibility of real-time monitoring, hindering the adoption of effective preventive measures.

Traditional insect-killing devices, such as electric traps and UV lamps, while effective in some situations, often have limitations regarding data collection and automation of control processes. The inability to perform intelligent analysis or integrate real-time data collection capabilities limits the use of these devices in more complex applications such as large crop fields or delicate ecosystems, where preserving environmental balance is crucial.

Given the challenges faced by the aforementioned state-of-the-art technologies, there is a growing demand for pest control systems combining efficiency, sustainability, and intelligence. Solutions integrating renewable energy sources, such as solar panels, wireless network technologies (LoRa), and that also enable data collection and transmission for real-time remote monitoring represent a necessary advancement compared to current solutions.

This new technological landscape opens room for the creation of devices with multiple functionalities, capable of effectively eliminating pests, while offering detailed monitoring of their presence and activity, minimizing environmental impact.

### SUMMARY OF THE INVENTION

The present invention aims to develop an intelligent, autonomous insect extermination and monitoring system that overcomes the limitations of traditional pest control methods. The invention aims to provide an environmentally sustainable solution, utilizing solar energy and integrating advanced data collection and transmission technologies for real-time monitoring.

The invention, called the “Tower Hunter” system, consists of a main tower structure and several slave towers, which work together to eliminate pests, collect images and data on insect presence, and transmit this information to a central server. The use of LoRa communication networks and artificial intelligence modules allows for the system identify and count the insects eliminated, promoting a more efficient and informed approach to pest control in agricultural and ecologically sensitive environments.

Furthermore, the invention aims to provide a modular structure, with easily installable and low environmental impact components, which enables effective insect elimination with no need for pesticides. The system is designed to operate in remote conditions, with automated operation and energy self-sufficiency, reducing operating costs and increasing the safety and sustainability of pest control practices.

### BRIEF DESCRIPTION OF THE INVENTION

The present invention relates to an intelligent, autonomous system for insect extermination and monitoring, called “Tower Hunter,” consisting of a main tower and multiple slave towers working together to eliminate pests and monitor their activity in real time. The system uses renewable energy sources, such as solar panels, and integrates advanced technologies, including LoRa communication networks and artificial intelligence, for data collection and insect recognition.

The main tower is equipped with a central controller (Raspberry Pi), cameras to capture images of the insects eliminated, and a 4G transmission system that sends data to a remote server. Based on these images, the server uses deep learning algorithms to identify and count the insects. Furthermore, the system features high-voltage grids that, when activated, eliminate insects coming into contact with the grid, offering an effective and environmentally friendly alternative to the use of pesticides.

The system is modular and autonomous, capable of operating in remote locations with no need for frequent human intervention. Slave towers connect to the main tower via a LoRa network, performing auxiliary killing functions and providing additional data for monitoring. The system also features automatic high-voltage grid cleaning mechanisms, ensuring uninterrupted operational continuity.

The invention provides a more efficient and sustainable method of pest control with the advantage of offering intelligent and automated monitoring, ideal for applications in agriculture and environmental preservation, where ecological balance is essential.

### BRIEF DESCRIPTION OF THE DRAWINGS

The present invention will be described in more detail below with reference to the attached figures which, in a schematic manner and not limiting the inventive scope, represent examples of embodiment thereof. The drawings show:

FIG. 1 illustrates the autonomous tower system in accordance with one aspect of the present invention;

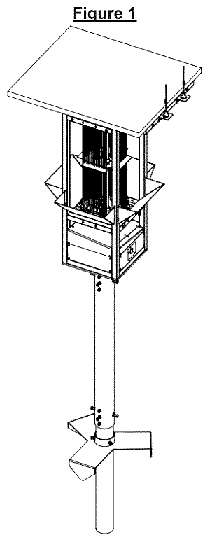

FIG. 2 illustrates a logic diagram of the main tower in accordance with one aspect of the present invention;

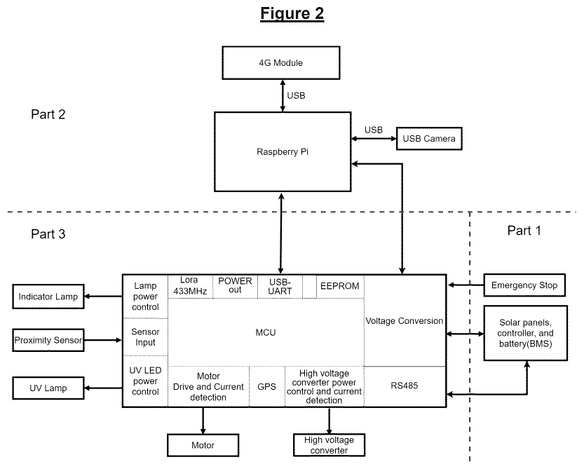

FIG. 3 illustrates a logic diagram of a slave tower in accordance with one aspect of the present invention;

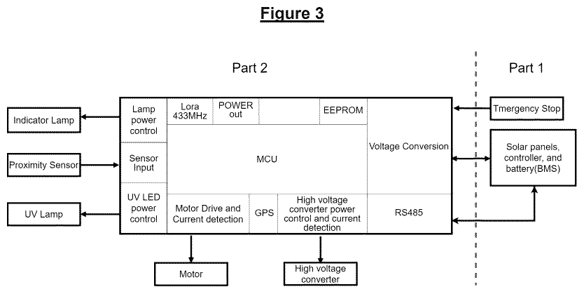

FIG. 4 illustrates a logic diagram of the sequence of instructions implemented in the main tower in accordance with one aspect of the present invention;

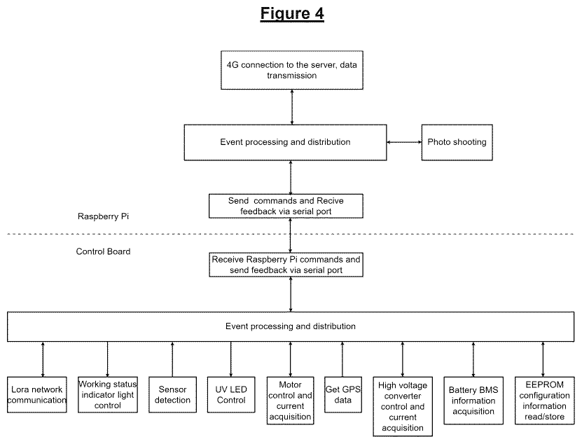

FIG. 5 illustrates a logic diagram of the sequence of instructions implemented in the slave tower in accordance with one aspect of the present invention.

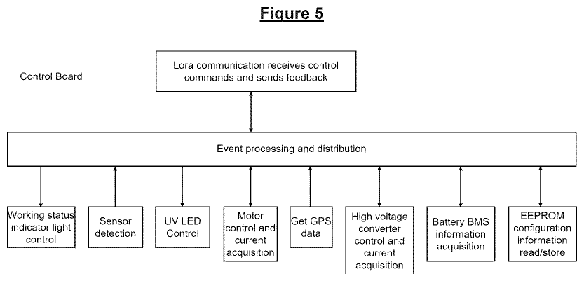

### DETAILED DESCRIPTION OF THE INVENTION

Below is a detailed description of a preferred embodiment of the present invention, which is exemplary and in no way limiting. However, possible additional embodiments of the present invention still encompassed by the essential and optional features below will become clear to one skilled in the art upon reading this description.

The present invention concerns an autonomous and intelligent insect extermination and monitoring system, called “Tower Hunter,” designed for large-scale use, especially in agricultural environments and ecologically sensitive areas. The system aims to solve the problems associated with traditional pest control methods by utilizing renewable energy and incorporating real-time monitoring technologies, eliminating the need for pesticides, and mitigating environmental impacts.

The proposed solution is equipped with a system composed of a main tower and multiple slave towers. Each tower is equipped with components enabling autonomous operation and interaction between devices. The main tower centralizes system control, while the slave towers connected to the main tower via a LoRa network assist with kill and data collection functions.

### Main Tower

The Power System is a self-sustaining energy system composed of solar panels, a solar controller, and a storage battery. This system ensures the tower operates continuously, even in remote areas with no access to the power grid.

The main control and operation component of the tower is the Raspberry Pi, which centralizes control over all operations of the main tower. It manages operational events, collects data from slave towers, and maintains the LoRa communication network for transmitting information between towers and to the remote server.

Image acquisition and analysis are performed by a camera installed on the main tower that captures images of insects killed by the high-voltage grid. These images are processed by a Raspberry Pi, which interacts with the server via a 4G module. The server runs an artificial intelligence algorithm that identifies the type and quantity of insects.

The main tower is equipped with a high voltage grid (+Voltage Grid/−Voltage Grid) that is activated when insects touch the grid, releasing a high voltage discharge that instantly eliminates the insects.

### Slave Towers

Each slave tower is also equipped with a solar panel, solar controller, and a battery, ensuring continuous operation.

Slave towers connect to the main tower via a LoRa module, and their functions include assisting in insect eradication and expanding the system's coverage area. They provide additional data to the main tower for comprehensive monitoring.

The “Tower Hunter” system structure is comprised of a series of components enabling efficient insect elimination and intelligent monitoring. These components include power systems, high-voltage networks, cleaning mechanisms, cameras, and data processing systems.

### Solar Power System

Each main and slave tower uses solar panels to collect energy and maintain system operations. The DHS-MPPC solar controller manages battery charging and power delivery to the electronics and the high-voltage grid.

### High Voltage Network for Insect Extermination

The high-voltage grid consists of a positive (+) voltage grid and a negative (−) voltage grid designed to release an electric discharge when insects come into contact with the grid. The system is capable of eliminating a wide range of insects by adjusting the distance between the grids and the discharge power as needed.

The grid structure is mounted on a fixing plate that ensures the stability of the grid, while insulating sections protect the electrical connections.

### Automatic Cleaning Mechanism

The system includes two movement mechanisms: the Trapezoidal Screw Assembly and the Synchronized Belt Assembly. These mechanisms drive brushes that regularly clean the high-voltage grid, removing dead insects to ensure continuous operation. Integrated sensors detect the brush position and control its movement along the grid.

### Image Acquisition and Intelligent Processing

A camera positioned on the main tower collects images of the insects eliminated. These images are transmitted via 4G to a remote server, where a deep learning algorithm identifies the insect species and counts the number eliminated. This allows for detailed and accurate monitoring of pest populations, providing valuable information for preventive and control actions.

### Communication and Control via Lora Network

The main tower creates a LoRa communication network to connect the slave towers. Through this network, the slave towers transmit data and receive commands from the main tower. This system allows coordination between all towers, ensuring synchronized and efficient operation over large areas.

### System Operation

After installation and configuration, the Hunter Tower system operates autonomously. During the day, solar panels generate power and charge the batteries. When insects enter the tower's range at night, UV lamps attract them, and the high-voltage grid is activated, killing the insects. The cleaning mechanism ensures the grid remains functional by removing dead insects.

The cameras capture images of the insects eliminated, and the software system, running on the Raspberry Pi and the remote server, processes the information and makes it available for remote monitoring. Integration with the server allows the towers to operate intelligently, adjusting their operation as needed and transmitting real-time data on the number and type of insects eliminated.

### Advantages of the Invention

The system is powered by solar energy, making it environmentally friendly and self-sustainable, ideal for remote areas.

Another advantage is the combination of high voltage, artificial intelligence technology, and automatic sensors, providing an efficient and autonomous system for insect extermination and monitoring.

Furthermore, continuous data collection and remote processing allow precise control over insect populations, enabling preventive and efficient actions.

Finally, the automatic cleaning system minimizes the need for frequent maintenance, allowing prolonged operation with no manual intervention.

It should be noted that the embodiments described herein in the present specification are intended to clarify and provide sufficient descriptiveness for the invention, however the scope of protection of the invention is delimited by the claims.

1. AN AUTONOMOUS TOWER SYSTEM FOR INSECT EXTERMINATION AND MONITORING, comprising a main tower and at least one slave tower,
wherein the main tower comprises:
a self-sustaining power system composed of a solar panel;
a solar charge controller and a storage battery configured to provide continuous power, independent of an external electricity source;
a centralized control device using a microcomputer (Raspberry Pi) managing the system operation and collecting data from the slave towers through a LoRa communication network;
a built-in camera for capturing images of eliminated insects, connected to a 4G module for transmitting the images to a remote server, where an artificial intelligence algorithm processes and identifies the species and quantity of insects;
a high voltage grid composed of a Positive Voltage Network (+) and a Negative Voltage Network (−), configured to release an electric discharge upon contact with insects, eliminating them instantly,
wherein each slave tower comprises:
a power supply system consisting of a solar panel, solar controller, and battery, ensuring independent operation from an external power source;
a LoRa communication module configured to connect to the main tower and transmit monitoring data, in addition to receiving commands, allowing for expanded coverage area and auxiliary action in insect extermination.

2. THE AUTONOMOUS TOWER SYSTEM, according to claim 1, characterized in that the high voltage grid of the main tower is supported by a fixing plate with insulating sections, ensuring the structural stability and safety of the electrical connections.

3. THE AUTONOMOUS TOWER SYSTEM according to claim 1, further comprising an automatic cleaning mechanism including:
a set of trapezoidal screws and a set of synchronized belts configured to move cleaning brushes along the high-voltage grid;
integrated sensors to detect the position of the brushes and control their movement, ensuring the removal of insects eliminated from the grid.

4. THE AUTONOMOUS TOWER SYSTEM according to claim 1, wherein each main or slave tower comprises a solar panel for energy collection and a DHS-MPPC solar controller for battery charge management and power supply to the electronic components and to the high voltage grid.

5. THE AUTONOMOUS TOWER SYSTEM according to claim 1, characterized in that the main tower is configured to establish a communication network with the slave towers, allowing for real-time data transmission and remote control.
